(19) United States
(12) Patent Application Publication
(10) Pub. No.: US 2007/0162905 A1
(43) Pub. Date: Jul. 12, 2007

(54) Use loader for signaling the system software update service

(76) Inventor: Sander R. Kooijmans, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/586,916

(22) PCT Filed: Jan. 25, 2005
(86) PCT No.: PCT/IB05/50292

§ 371 Date: Jul. 24, 2006

Related U.S. Application Data
(60) Provisional application No. 60/539,723, filed on Jan. 28, 2004.

(51) Int. Cl. G06F 9/44

(52) U.S. Cl. 717/173; 717/168; 717/172

(57) ABSTRACT

A receiver (50) having software contained within a non-volatile memory (52) that can be upgraded via a communication interface (62). The receiver (50) provides a standby mode that works in conjunction with an operational mode to search (16) for and load (28) software updates. If an available update is found, the receiver records an indication (44) that a software update is available to allow for loading (28) and installing (22) of the update. The receiver can locate updates in the standby mode generate an indication for the receiver that upon entering the operational mode, the indication that a software update is available is identified and the system software then loads the new software update. The receiver is capable of searching for software updates during the operational mode and if available update is found, the receiver loads it the update into memory and upon re-entering of the standby mode, the update stored in memory is placed into a predetermined non-volatile memory so that the update is available the next time the operating mode is entered.

The present invention pertains to receiver devices, and more particularly to software upgrades for set top boxes.

In current implementations of set top boxes, receivers within the set top box contain functions related to searching for system software updates. Typically, set top boxes will have system software that performs the normal broadcast receiving functions of the set top box. Additionally, loaders are implemented within the receivers that are responsible for finding the update service in order to perform a system software update. The receiver must be able to find this system software update service to obtain data about the system software updates (such as descriptions of new system software, version numbers, start and end times of system software update broadcasts, estimated duration of system software update, etc.). A problem within these conventional implementations is that the system software search functions within the system software and the loader can differ in the code that is used (a situation that can occur if the loader is bought from a third party) and result in incompatibilities between the system software and the loader. These situations can lead to inconsistencies in dealing with system software updates between the system software and the loader. For instance, the system software might find the system software update service and inform the user that a system software update will be started. However, if the loader does not find the system software update service, due to a lack of communication or basic incompatibility, the system software update will not take place.

From the foregoing discussion, it should be apparent that there remains a need within the art of set top boxes for a system software and loader configuration that can update the system software in a consistent manner.

The present invention addresses the shortcoming within the prior art by providing a receiver having a plurality of modes on the receiver such that at least a first mode is a normal operating mode for the receiver and a second mode searches for software updates for the receiver, searching for software updates in at least one of the modes, indicating to one of the modes within the receiver the availability of software updates, transferring available software updates to the receiver; and installing transferred software updates into the receiver.

It is an object of the invention to provide a system connected to a network and configured with non-volatile memory within the system that can be upgraded via the network connection.

It is a further object of the invention to provide a system with a standby mode in which the system searches for software updates, and provides an indication to the system that a software update is available.

It is a further object of the invention to provide a system with an operational mode wherein the system perceives an indication that a software update is available and the system software loads the software update.

It is a further object of the invention to provide a system with an operational mode that can search for available software updates during the operational mode and transfer available software updates into the system.

It is still further an object of the invention to provide a system with a stand-by mode that upon re-entering the standby mode, a loading program loads software updates that have been transferred to the system.

These and other objects are provided by a system connected to network and having software contained within a non-volatile memory that can be upgraded via a network connection. The system provides a standby mode wherein the system searches for software updates, and if an available update is found, the system records an indication that a software update is available. Upon the system entering an operational mode, the indication that a software update is available is identified by the system and the system software then loads the new software update. The system is capable of searching for software updates during the operational mode and if available update is found, the system loads it the update into memory and upon re-entering of the standby mode, the update stored in memory is placed into a predetermined non-volatile memory so that the update is available the next time the operating mode is entered.

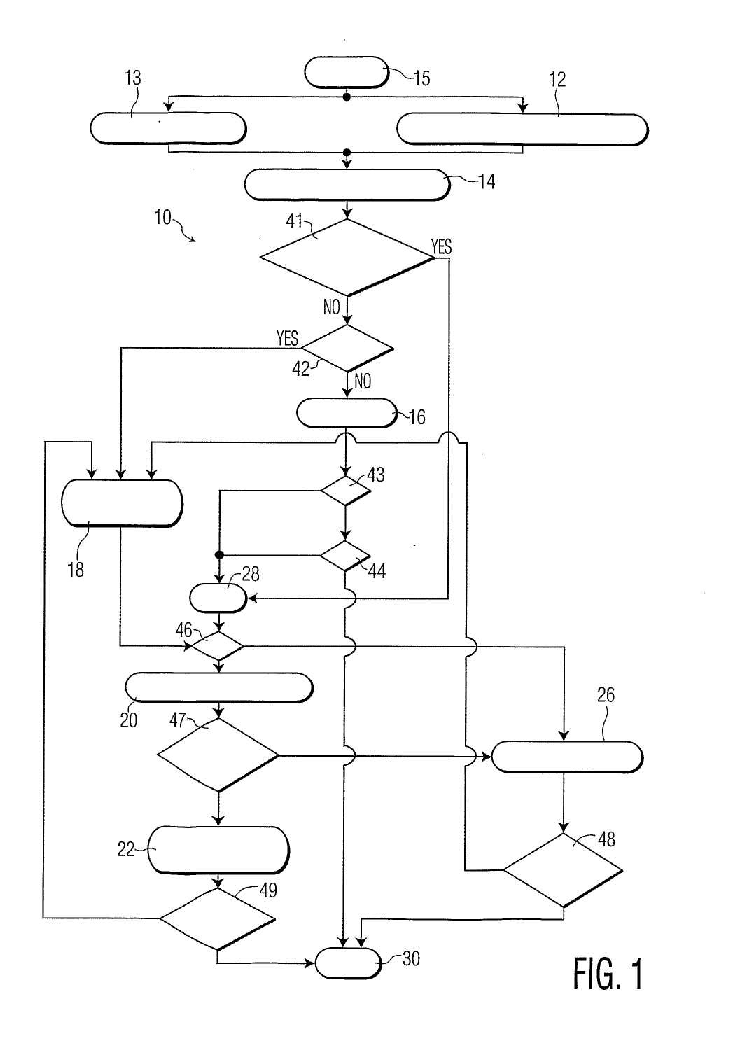

FIG. 1 is a flowchart illustrating the preferred embodiment of the invention;

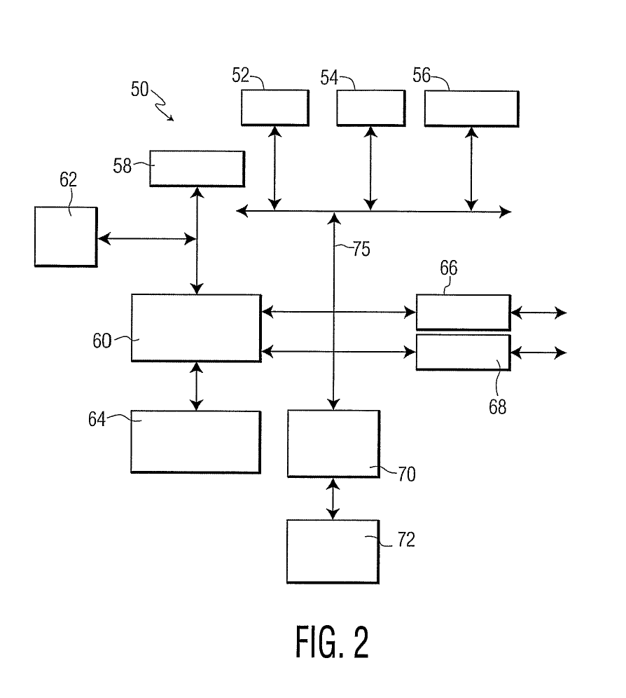

FIG. 2 is a block diagram for a set top box for running the algorithm of FIG. 1.

FIG. 1 is a flowchart for the loader 10 that is used for practicing the invention. FIG. 2 is a block diagram for the hardware 50 within a typical set-top box that is capable of running the loader 10 algorithm illustrated by the flowchart and FIG. 1.

Referring to FIG. 2, the hardware 50 for the set-top box will have a front-end 62 that operates under direct control of input/output controller 60. The front panel controls 64, which can also be a remote control, will provide commands to the input output controller 60. Input/output controller 60 can also receive and transmit data via IEEE1394 interface 66 or RS 232 interface 68. Data that is received by the set-top box hardware 50 will come into the front-end and 62 and then placed in memory 58. Memory 58 can be either volatile or non-volatile memory, it is preferably some type of the DRAM. The system software that runs the set-top box typically resides within a non-volatile type of memory, such as flash memory. There are other types of non-volatile memory, for example EEPROM, FLASH memory, or battery powered DRAM which can all be written to but will not lose their contents once system power is removed. FLASH 52 is the flash-memory that is employed by the preferred embodiment of the present invention to retain the current version of the system software. The set-top box hardware 50 will operate under control of CPU 70 via CPU bus 75. In addition to CPU 70 and FLASH 52, DRAM 54 and memory 56 also reside on CPU bus 75 as resources that can be used by CPU 70. Additionally, CPU 70 interfaces with video graphics 72 over a separate dedicated bus. As envisioned by the preferred embodiment, video graphics 72 has at least one memory resource.

Preferably in set-top box hardware 50, and typically within the digital television domain, the system software of the receiver (for either set-top box or digital television) is for the most part stored in flash memory because flash memories are non-volatile and can be written to. FLASH 52 is the flash memory within the preferred embodiment that is used to store the system software. The set-top box hardware 52 uses a flash memory to retain the system software because it is possible to update the system software within a non-volatile memory that can be written. There are other types of non volatile memories that can be written such as EEPROM or battery powered volatile memories however flash memory's preferred by the preferred embodiment due to expense, integration density and simplicity in design and manufacturing.

In set-top box hardware 50, and typically within the digital television domain, typically updates to the system software for the set-top box will be received by the front-end 62 and temporarily placed into memory 58. The new system software is typically broadcast on a separate service within the broadcast stream. To perform a system software update, the set-top box must first find the service containing the new system software, then load the new system software in memory 58, and finally (after verifying the new system software is correct), store the new system software in some type of non-volatile memory, which in the preferred embodiment is FLASH 58 memory.

The preferred embodiment, from a software point of view, envisions that the receiver portion of the set-top box will have two basic components. The first component is the system software that runs on the set-top box and the second component is the loader 10 that retrieves upgrades to the system software.

The system software is the software that provides the nominal behavior of the receiver. The loader 10 is the software that searches for the system software update service and performs the actual software upgrade. The system software and the loader 10, conventionally, can not execute at the same time.

Current implementations of receivers incorporate the functionality of searching for the system software update service both within the system software and in the loader. These conventional implementations can result in search functions that are not entirely compatible. This situation can lead to inconsistencies in retrieving system software updates.

The present invention address this problem by providing a loader 10 having functionality that is extended such that the loader 10 can be started in two different modes. The first mode allows the loader 10 to search for the system software update service. The second mode allows the loader 10 to search for the system software update service and, if the loader 10 finds this service, it starts performing a system software update. The first mode is not provided for in current loader implementations. The present invention provides system software that does not search for the system software update service itself, but instead employs a separate loader 10 to perform the function of searching for the system software update service, akin to the first mode 1 discussed above.

As mentioned previously, the loader 10 and the system software do not typically execute at the same time. Typically, a location within a non-volatile memory, such as flash or EEPROM, is used to indicate whether the loader 10 or the system software must be started after switching on the power or after performing a reset. Further, this non-volatile memory, such as flash or EEPROM, will also be used to pass information (e.g., a locator referring to the system software update service) between the loader and the system software. One way to let the system software use the loader 10 for finding the system software update service is the following: when the receiver is about to go to standby, the system software passes information to the loader and then resets the receiver. The receiver starts the loader 10 in the first mode wherein the loader 10 will search for the system software update service. Once the loader 10 has finished searching, it puts the receiver in a standby mode. Upon the receiver being powered on again (i.e., leaves the standby mode), the system software checks whether the loader 10 has found the system software update service. There are numerous ways that the system software can verify the status returned by the loader 10, such as setting a flag or modifying a semaphore in software, allowing the system software to act accordingly. If the loader 10 indicates that an update is available, then the system software tunes to this service and retrieves any information it needs to download the update to the set top box.

FIG. 1 is a flowchart illustrating the operation of the loader 10 of the preferred embodiment of the present invention. The loader 10 as envisioned by the preferred embodiment of invention will typically begin 15 once the system is initially turned on, referred to herein as a cold boot. However, it should be noted, that numerous routines can initiate loader 10. The preferred embodiments of the invention describe calls to the algorithm in FIG. 1 that are made in either an operational mode or a standby mode. The invocation of the algorithm illustrated in FIG. 1 will be referred to, generally, as begin 15. Upon being called (such as during initial power on or changing of modes), the loader 10 will perform two tasks. The first task is to verify current image 13 where the software image checks the image that is currently in the system. Verify current image 13 checks the current image to determine whether it is damaged and is preferably implemented by calculating a checksum or Cyclic Redundancy Checksum (CRC) of the image. The CRC can determine if two images or files are identical. The CRC function typically, processes each byte of an image or file. Any difference in images, or files, will produce a different CRC number. However, other implementations for verifying the current image are possible and will be readily apparent to those skilled in the art.

The second task is to check for forced download sequences 12. A forced download sequence as envisioned by the present invention can be initiated by the home user of the set top device by entering a predetermined sequence of buttons on the remote control or the receiver. Additionally, a forced download sequence can be initiated by service personnel at a repair shop. Once initiated, a forced download sequence retrieves what is referred to herein as the standard image. The standard image is the image that was originally placed in the set top device.

Embodiments are envisioned that perform check for forced download sequence 12 before performing verify current image 13 and if the necessary sequence has not been entered to initiate a forced download sequence prior to performing verify the current image 13. However, the preferred embodiment does not perform check for download sequence 12 prior verifying the current image because checking for the forced download sequence relates to catastrophic events, requires inputs be made into the system and takes time for a function that rarely needs to be performed. In the preferred embodiment, check for forced download sequence 12 is performed essentially in parallel with verify current image 13. The functions forced download sequence 12 and verify current image 13 may be performed independently from each other, which is done in the preferred embodiment. The preferred embodiment also provides hardware within the system that allows the functions forced download sequence 12 and verify current image 13 to be implemented as two functions that are executed in parallel.

Test local download server 14 will search for a download server that has available upgrades that can be downloaded after the loader performs forced download sequence 12 and verify current image 13. A local download server can be software running on a PC at the same location as the set top box or at a local shop where the user can bring the system for repair. Test local download server 14 is a useful in instances where the software image in the system becomes corrupt and no software images are currently being broadcasted. The use of a local download server (either in the home or at a shop) allows the user to get a correct software image into the system again. It is the intent of the preferred embodiment, that the local download server be used for emergency situations. If a download server is detected, then the image that is available at this server will be the selected image.

Once test local download server 14 is performed, decision block 41 will identify the result of test local download server 14 and route program operation accordingly. If decision block 41 determines that no download server is detected, then decision block 42 will determine if a forced download sequence was detected as previously discussed. If decision block 42 determines that no forced download is detected, then the loader 10 performs select image 16. Select image 16 is the step where the loader 10 searches the broadcasted signal for a software update. In typical operation, the loader 10 will not detect a download server or a forced download, therefore, select image 16 will normally be performed. If a software update is available, the loader 10 will run the function download selected image 28 to retrieve the update into the set top box. Decision block 43 will test the image for possible corruption. If decision block 43 determines that the current image is corrupt, then loader 10 will perform download selected image 28 to retrieve an update into the set top box. Typically, there will only be one software image broadcasted at any time for one specific system. As previously stated, in the event that decision block 41 determines that a download server has been detected, then the image available from this server will be the selected image.

Decision block 44 will identify if the selected image is the current image. It is entirely possible that decision block 44 will determine that the selected image may be the same as the image currently in use within the set-top box. If the current image is the selected image, then it is assumed that the image currently written in the flash memory is correct and the routine is terminated. It will be readily apparent to those skilled in the art that the functions performed by decision block 43 in testing the image for corruption and decision block 44 for identifying if the current image is the selected image can be combined into a single function. The intention is that a download takes place if the current image is corrupt or if an image is selected other than the current image. It should be noted that it is possible that a selected image is the same as the current image. This typically happens after a successful software upgrade, which is not uncommon because a single software image may be broadcasted for several months or even several years.

If decision block 41 determines that a download server is detected, then the loader performs download selected image 28 to retrieve the update from that server as previously discussed.

After download selected image 28 is performed, the selected image is tested to verify that it was downloaded correctly at decision block 46. If the download of the selected image is determined by decision block 46 to be successful, then verify downloaded image 20 determines if the image is corrupt and decision block 47 branches program operation accordingly. If decision block 47 determines that the downloaded image is corrupt, a branch is made to load current image 26 to load the existing image. If decision block 47 determines that the downloaded image is not corrupt, then the image is written to flash memory and the loader 10 returns to system software operation. If decision block 49 determines that the write is not successful, then operation branches to download standard image 18.

Returning to download selected image 28, if the download of the selected image is determined to have failed by decision block 46, then steps are taken to restore the existing image by load current image 26. The existing image is then tested for corruption by decision block 48. If the existing image is found to be free of corruption, program operation branches to return and loader 10 is exited. If the existing image is found to be corrupt, then program operation branches to download standard image 18 and decision block 46 again tests the image, only this time it is the standard image.

Returning again to decision block 41, if a determination is made that no download server is detected, then the program branches to decision block 42 to identify if there is an indication of a forced download sequence. If a forced download sequence is detected, then operation branches to download standard image 18 which will initiate a download sequence into the set-top box that retrieves the original image into the set top box. Operation will then branch again to decision block 46, which will check for the correctness of the download. If decision block 46 determines that the image has downloaded correctly, then the image is verified and written to flash memory as previously discussed. If decision block 47 determines that the image is corrupt then the system performs load current image 26. If the current image is successfully verified, then the routine terminates 24. If the current image does not correctly verify, then a series of steps are performed to correct and restore the image.

The invention provides advantages in implementing functions to search for the system software update services while assuring that the loader will not be incompatible in any way because the system software and the loader 10 are fully cognizant of each other. Preferably, the loader 10 and the system software use the same code. Additionally, the size of the system software is reduced having a centralized approach to the design of loader 10 and the system software. The preferred embodiment employs the specification for system software updates in DVB systems as detailed in the following document: ETSI TS 102 006 VI .2.1 (2002-10), Digital Video Broadcasting (DVB); Specification for System Software Update in DVB Systems.

The foregoing discussion describes the embodiments most preferred by the inventor. Variations of these embodiment will be readily apparent to those skilled in the art, accordingly, the scope of the invention should not be limited by the above discussed embodiments but be measured by the appended claim.

1. A method for updating software comprising the steps of:
implementing a plurality of modes on a receiver device (50) such that at least a first mode is a normal operating mode for the set top device and a second mode (10) searches for software updates;
searching (16) for software updates with at least one of the modes;
indicating (44) to one of the modes within the receiver device on occurrences of available software updates;
transferring (28) available software updates to the receiver device; and
installing (22) transferred software updates into the programmable device.

2. The method of claim 1 wherein the step of implementing further comprises as the plurality of modes an operational mode and a standby mode.

3. The method of claim 2 wherein the steps of searching (16) and transferring (28) are done in the standby mode.

4. The method of claim 2 wherein the steps of searching (16) and transferring (28) are done in the operational mode.

5. The method of claim 3 wherein the step of searching (16) further comprise in the standby mode searching for software updates, and if software updates are found an indication that software updates are available is made.

6. A receiver system (50) with a communication interface (62), the system (50) containing software in a non-volatile memory (52) that can be upgraded via network connection comprising:
a standby mode within the receiver system (50) that works in conjunction with an operational mode to install software updates, wherein the receiver system (50) normally functions in the operational mode, and the standby mode does not function simultaneously with the operational mode; and
a routine (10) operative in either the operational mode or the standby mode to provide an indication (16) of availability for software updates that is used by the other of either the operational mode or the standby mode to identify the indication and assist in installing software updates into the receiver.

7. The system of claim 6 wherein the standby mode identifies the existence of software updates and the operational mode installs available updaters in the receiver.

8. The system of claim 6 wherein the operational mode will identify the existence of available software updates and the stand by mode will load available software updates into the receiver.

9. The system of claim 6 wherein the routine places software updates into a volatile memory that is later placed into the non-volatile memory.

10. The system of claim 9 wherein the routine places software updates into the volatile memory in the standby mode and the receiver places software updates into the non-volatile memory after reentering the operational mode.

11. A receiver system (50) with a non-volatile memory (52) that can be altered comprising:
a communication interface (62) in the receiver system that is operatively coupled to the non-volatile memory (52) under control of processing means within the receiver system;
system software means within the receiver that performs normal operation of the receiver system; and
a loader (10) that functions independently from the system software means to search (16) for software updates and retrieve (28) updates that are found;
wherein the loader runs upon an occurrence of one of a plurality of predetermined events.

12. The receiver system of claim 11 wherein the system software means runs in an operational mode wherein the system is operative to receive broadcast signals and the loader runs in a standby mode wherein normal broadcast reception functions are disabled.

13. The receiver system of claim 12 wherein the operational mode identifies that software update are available to the loader, and the loader retrieves available software updates.

14. The receiver system of claim 12 the standby mode identifies available software updates and the operational mode installs available software updates.

15. The receiver system of claim 12 wherein the receiver can locate updates in the standby mode generate an indication for the receiver that upon entering the operational mode, the indication that a software update is available is identified and the receiver then loads the new software update.

16. The receiver system (50) of claim 11 wherein the plurality of predetermined events further comprises applying power to the receiver system (50).

17. The receiver system (50) of claim 11 wherein the plurality of predetermined events further comprises changing channels on receiver system (50).

18. The receiver system (50) of claim 11 wherein the plurality of predetermined events further comprises an input to the receiver system (50)
